(19) United States
(12) Patent Application Publication
(10) Pub. No.: US 2015/0340683 A1
(43) Pub. Date: Nov. 26, 2015

(54) POSITIVE ELECTRODE MATERIAL FOR LITHIUM SECONDARY BATTERY

(71) Applicant: JFE MINERAL COMPANY, LTD., Tokyo (JP)

(72) Inventors: Yoshiaki Hamano, Tokyo (JP); Yosuke Iwasaki, Tokyo (JP)

(21) Appl. No.: 14/652,894

(22) PCT Filed: Dec. 9, 2013
(86) PCT No.: PCT/JP2013/007223

§ 371 Date: Jun. 17, 2015

(30) Foreign Application Priority Data
Dec. 21, 2012 (JP) 2012-280170

(51) Int. Cl. H01M 4/131; C01G 53/00; H01M 4/525; H01M 4/485; H01M 4/505

(52) U.S. Cl. CPC H01M 4/131; H01M 4/485; H01M 4/505; H01M 4/525; C01G 53/66; C01G 53/50; H01M 2004/028

(57) ABSTRACT

A positive electrode material is used for a lithium secondary battery. The material includes a complex oxide whose overall composition is expressed by LiₐNi_{b}M_{c}N_{d}LₑOₓ, where M: one or two chemical elements selected from Mn and Co, N: one, two, or more chemical elements selected from the group consisting of Mg, Al, Ti, Cr, and Fe, L: one, two, or more chemical elements selected from the group consisting of B, C, Na, Si, P, S, K, Ca, and Ba, and where a/(b+c+d): 0.80 to 1.30, b/(b+c+d): 0.30 to 0.95, c/(b+c+d): 0.05 to 0.60, d/(b+c+d): 0.005 to 0.10, e/(b+c+d): 0.0005 to 0.010, b+c+d=1, and x: 1.5 to 2.5.

### TECHNICAL FIELD

This disclosure relates to a new positive electrode material for a lithium secondary battery composed of lithium containing complex oxides and to a method of manufacturing the material.

### BACKGROUND

Nowadays, there is a growing expectation for secondary batteries which are small and light and which have a high energy density, in particular for lithium secondary batteries, due to portable or cordless devices being used more than ever. Known examples of a positive electrode material for lithium secondary batteries include complex oxides of lithium and transition metals such as LiCoO₂, LiNiO₂, LiNi_{0.8}Co_{0.2}O₂, LiMn₂O₄, and LiMnO₂. It is possible to achieve a comparatively high capacity density of 180 to 200 mAh/g by using a lithium secondary battery whose positive electrode material is composed of a complex oxide having a layered rock salt structure with a solid solution of cobalt and nickel such as LiNi_{0.8}Co_{0.2}O₂. In addition, the lithium secondary battery has good reversibility in a high voltage range of 2.5 to 4.5 V.

Recently, in particular, lithium-nickel-cobalt complex oxides represented by LiNi_{0.8}Co_{0.2}O₂ have been started to be used as materials which can achieve a high capacity. Commercialization of a lithium secondary battery having a high voltage and high energy density is being facilitated by using such materials as positive electrode materials and by using, for example, carbon materials, which can occlude and release lithium, as negative electrode materials.

The positive electrode material is the material that plays the most important role in the battery performance and safety of a lithium secondary battery. Nowadays, complex metal oxides such as LiCoO₂, LiMn₂O₄, LiNiO₂, LiNi₁₋ₓCoₓO₂, and LiMnO₂ are being investigated.

Among such positive electrode materials, Mn-containing positive electrode materials such as LiMn₂O₄ and LiMnO₂ are easy to be synthesized and comparatively inexpensive, but they are disadvantageous in that they can only achieve a small discharge capacity. Although Cocontaining positive electrode materials such as LiCoO₂ achieve good electrical conductivity, high battery voltage, and excellent electrode performance, there is a problem in that Co metal, which is a main raw material, is rare and expensive. Ni-containing positive electrode materials such as LiNiO₂ use Ni metal, which is comparatively inexpensive among the positive electrode materials described above, as a main raw material and are excellent in terms of practical discharge capacity when used in a battery, although the theoretical discharge capacity of the Ni-containing positive electrode materials is not much different from that of LiCoO₂. However, the Ni-containing positive electrode materials are disadvantageous in that they are difficult to be synthesized.

Japanese Unexamined Patent Application Publication (Translation of PCT Application) No. 2007-517368 describes an electrode material composed of LiₐM_{b}O₂, where M=A_{z}A′_{z′}M′_{1-z-z′}, where M′ represents Mn, Ni, and Co, where A represents metals selected from among Al, Mg, Ti, and Cr, and where A′ represents chemical elements selected from among F, Cl, S, Zr, Ba, Y, Ca, B, Be, Sn, Sb, Na, and Zn (claim 3). That electrode material is a powder having a particle size distribution, and a technique in which the composition M is varied in accordance with the particle size is disclosed (claim 5).

Various positive electrode materials having various chemical compositions have been investigated in conventional techniques. However, in lithium secondary batteries using the positive electrode materials according to conventional techniques, further improvement is required in terms of discharge capacity, charge-discharge efficiency, rate performance, and safety. In particular, when a positive electrode material is a composition which undergoes a large change in mass with time in atmospheric air, there is a problem in that the change has an influence on the product quality of a lithium secondary battery which is manufactured using the material.

We provide a new material (hereinafter, referred to positive electrode material) used as a positive electrode material for a lithium secondary battery which achieve high safety, high capacity, and excellent rate performance, which does not undergo deterioration, and which has a Li—Ni—Co—O-containing, Li—Ni—Mn—O-containing, or Li—Ni—Mn—Co—O-containing chemical composition.

We provide a positive electrode material for a lithium secondary battery which is composed of a complex oxide composition comprising Li—Ni—Co(or Mn)—O-containing material and two or more other chemical elements, a method of manufacturing the material, and a lithium secondary battery manufactured using this new material, as follows:
(1) A positive electrode material for a lithium secondary battery, the material being a complex oxide whose overall composition is expressed by LiₐNi_{b}M_{c}N_{d}LₑOₓ, where
   M: one or two chemical elements selected from Mn and Co,
   N: one, two, or more chemical elements selected from the group consisting of Mg, Al, Ti, Cr, and Fe,
   L: one, two, or more chemical elements selected from the group consisting of B, C, Na, Si, P, S, K, Ca, and Ba, and where
   a/(b+c+d): 0.80 to 1.30,
   b/(b+c+d): 0.30 to 0.95,
   c/(b+c+d): 0.05 to 0.60,
   d/(b+c+d): 0.005 to 0.10,
   e/(b+c+d): 0.0005 to 0.010,
   b+c+d=1, and
   x: 1.5 to 2.5.
(2) The positive electrode material for a lithium secondary battery according to item (1), the material undergoing a change in mass in an amount of 0.60 mass % or less after having been exposed to atmospheric air having a temperature of 25° C. and a humidity of 60% for 240 hours.
(3) The positive electrode material for a lithium secondary battery according to item (1) or (2), the material having a density of 3.20 g/cc or more in the compacted state with a load of 95.5 MPa.
(4) The positive electrode material for a lithium secondary battery according to any one of items (1) to (3), in which primary particles having an average particle diameter of 0.1 μm or more are aggregated to form secondary particles.
(5) The positive electrode material for a lithium secondary battery according to item (4), in which the difference between D₉₀ and D₁₀ based on number of particles is 5.0 μm or more in the particle size distribution of the secondary particles of the complex oxides.
(6) A method of manufacturing the positive electrode material for a lithium secondary battery according to item (1), the method including mixing raw material chemical elements or compounds containing raw material chemical elements, baking the resultant raw materials at a temperature of 700° C. or higher and 950° C. or lower in a baking process, and thereafter performing a treatment using a water-washing process.
(7) A lithium secondary battery, the battery comprising a positive electrode composed of a positive electrode material containing a positive electrode material for a lithium secondary battery according to any one of items (1) to (5), a negative electrode composed of a negative electrode material, and an ion-conducting medium which is interposed between the positive electrode and the negative electrode and which conducts lithium ions.
(8) The positive electrode material for a lithium secondary battery according to any one of items (1) to (5), the complex oxides being manufactured by baking after mixing Li compounds, a hydroxide which is formed by co-precipitating Ni and one or more chemical elements selected from Mn and Co and one, two, or more chemical compounds selected from among the oxides, nitrates, sulfates, carbonates, acetates, and phosphates of chemical elements other than the chemical elements described above.

The positive electrode material for a lithium secondary battery is a well-balanced, and excellent positive electrode material having high safety, high capacity, excellent rate performance, and stable in atmospheric air.

### DETAILED DESCRIPTION

Our electrode materials and methods will be described hereafter.

Positive electrode material for lithium secondary battery

The positive electrode material is a complex oxide whose overall composition is expressed by LiₐNi_{b}M_{c}N_{d}LₑOₓ, where
M: one or two chemical elements selected from Mn and Co,
N: one, two, or more chemical elements selected from the group consisting of Mg, Al, Ti, Cr, and Fe,
L: one, two, or more chemical elements selected from the group consisting of B, C, Na, Si, P, S, K, Ca, and Ba, where
a/(b+c+d): 0.80 to 1.30,
b/(b+c+d): 0.30 to 0.95,
c/(b+c+d): 0.05 to 0.60,
d/(b+c+d): 0.005 to 0.10,
e/(b+c+d): 0.0005 to 0.010,
b+c+d=1, and
x: 1.5 to 2.5,
and where Li: lithium, Ni: nickel, Mn: manganese, Co: cobalt, Mg: magnesium, Al: aluminum, Ti: titanium, Cr: chromium, Fe: iron, B: boron, C: carbon, Na: sodium, Si: silicon, P: phosphorus, S: sulfur, K: potassium, Ca: calcium, Ba: barium, and O: oxygen.

The chemical composition described above is expressed in terms of mole number under the assumption that the total mole number of Ni, M, and N is 1 mole (that is, b+c+d=1).

The Li content is 0.80 to 1.30 moles. When the Li content is low, since there is an increase in the amount of lithium deficiency in a crystal structure, there is a decrease in battery capacity when such a material is used for a positive electrode of a lithium secondary battery. When the Li content is excessively high, the slurry becomes gelled as a result of forming hydrates and carbonates such as lithium hydroxide and lithium carbonate when an electrode is manufactured and, therefore, the Li content is 0.80 to 1.30 moles, or preferably 0.85 to 1.20 moles.

The Ni content is 0.30 to 0.95 moles. There is a decrease in battery capacity when the Ni content is excessively low, and there is a decrease in stability when the Ni content is excessively high. It is preferable that the Ni content be 0.50 to 0.95 moles, or more preferably 0.60 to 0.95 moles.

Mn and Co, which are M elements, increase thermal stability, but, since there is a decrease in discharge capacity when the M content is excessively high, the M content is 0.05 to 0.60 moles, or preferably 0.05 to 0.40 moles. M elements and N elements may also be used as positive electrode raw materials in the form of a co-precipitated hydrates formed by combining the M elements and the N elements with Ni in advance.

The content of one, two, or more chemical elements selected from the group consisting of Mg, Al, Ti, Cr, and Fe, which are N elements, is 0.005 to 0.10 moles, or preferably 0.005 to 0.07 moles. When the N element content is within this range, since there is an appropriate decrease in crystallinity, there is an advantage in that Li ions are diffused in good condition. When the N element content is more than 0.10 moles, there is a decrease in battery capacity.

When one, two, or more chemical elements selected from the group consisting of B, C, Na, Si, P, S, K, Ca, and Ba, which are L elements, are added, the obtained positive electrode material undergoes a small temporal change in mass in atmospheric air at a normal temperature. It is preferable that C, S, and Ba be used as the L elements. The L elements are added in an amount of 0.0005 to 0.010 moles to increase thermal stability. When the L content is excessively low, it is difficult to achieve appropriate thermal stability for the positive electrode of the manufactured secondary battery. In addition, when the L content is more than 0.010 moles, there is a significant decrease in capacity. It is preferable that the L content be 0.001 to 0.008 moles.

The positive electrode material for a lithium secondary battery is characterized in that one, two, or more chemical elements selected from the group consisting of Mg, Al, Ti, Cr, and Fe, which are referred to as the N elements, and one, two, or more chemical elements selected from the group consisting of B, C, Na, Si, P, S, K, Ca, and Ba, which are referred to as the L elements are added to an oxide composition basically containing Li, Ni, Mn and/or Co. Although the functional effects of adding the N elements and the L elements are not entirely clear, it is preferable that the N elements be added because there is a particularly significant effect in achieving high-rate discharge performance. However, it is possible that the performance balance or safety of a battery decreases depending on the combination of the chemical elements and content ratios among them, and, in such a case, an increase in discharge performance is not achieved even though the N elements are added. Therefore, it is effective to combine the additive of N elements and the L elements.

We believe that, since there is an appropriate decrease in the crystallinity of a positive electrode material by adding chemical elements in the N element group, some influence on a Li ion transfer pathway being induced, there is an increase in Li ion conductivity. We also believe that the chemical elements in the L element group are effective in fixing excessive Li and preventing Li deficiency in the crystals of a positive electrode material by influencing the combined state of main chemical elements in the crystal system of the positive electrode material and that, as a result, deterioration of the positive electrode material in air is prevented by decreasing the amount of change in mass with time in atmospheric air at a normal temperature.

The positive electrode material for a lithium secondary battery is characterized in that a complex oxide is formed by adding small amounts of N elements in combination with L elements in amounts smaller than that of the N elements when some amount of Ni is replaced by Co and/or Mn. Co, Mn, and Ba contribute to high safety for a lithium secondary battery. We believe that Al and Mg are effective in increasing cycle performance when Al and Mg are added to the system and that Al, Ti, Cr, and Fe are effective in increasing rate performance.

It is preferable that the positive electrode material for a lithium secondary battery undergo a change in mass of 0.60 mass % or less, more preferably 0.50 mass % or less, or further more preferably 0.45 mass % or less, after having been exposed to atmospheric air having a temperature of 25° C. and a humidity of 60% for 240 hours. A change in mass is determined by the difference between a mass before exposure and a mass after exposure to atmospheric air controlled to have a temperature of 25±3° C. and a humidity of 60±5% for 240 hours.

Generally, it is said that a nickel-containing positive electrode material for a lithium secondary battery tends to absorb water and carbon dioxide. When moisture in the air is absorbed to the material, lithium hydrates is formed. The formed lithium hydrates absorbs carbon dioxide, and then lithium hydrogen carbonate and lithium carbonate are formed.

When the positive electrode material composed of a nickel-containing positive electrode material for a lithium secondary battery absorbs moisture, since the hydrolysis of LiPF₆, which is a generally used electrolytic salt, occurs, acids such as hydrofluoric acid and phosphoric acid are formed. The formed acids decompose some portions of the constituent materials of the battery to emit various gasses. Therefore, due to the emitted gasses, there may be battery swelling and a decrease in safety.

When a change in mass is 0.60 mass % or less after the material has been exposed to atmospheric air having a constant temperature of 25° C. and a constant humidity of 60% for 240 hours, it is possible to inhibit the occurrence of gelatification of a slurry for a positive electrode and to inhibit the occurrence of the swelling of the battery which are due to the phenomenon described above. In our system, it is possible to decrease the rate of change in mass by adding at least one of Ba, Ca, K, Na, S, C, Si, P, and B, which are chemical elements in the L element group.

It is preferable that primary particles having an average particle diameter of 0.1 μm or more be aggregated to form secondary particles in the positive electrode material for a lithium secondary battery. It is preferable for the positive electrode material that primary particles having an average particle diameter of 0.1 μm or more be coagulated to form secondary particles because there is a decrease in thermal stability when particles having a diameter of less than 0.1 μm are present. In the positive electrode material, secondary particles formed by polyhedral primary particles being aggregated in a substantially spherical shape are observed using an electron microscope at a magnification of 3000 times.

We provide a positive electrode material for a lithium secondary battery having as satisfactory a battery performance as possible by increasing the capacity per unit volume of a positive electrode as a result of increasing the density of the whole combined agent used for the positive electrode.

To achieve that, since it is effective to increase the filling rate of the particles of a positive electrode material, it is preferable that the particles have an appropriate particle size distribution.

When the overall composition of a complex oxide is expressed by LiₐNi_{b}M_{c}N_{d}LₑOₓ, where
M: one or two chemical elements selected from Mn and Co,
N: one, two, or more chemical elements selected from the group consisting of Mg, Al, Ti, Cr, and Fe,
L: one, two, or more chemical elements selected from the group consisting of B, C, Na, Si, P, S, K, Ca, and Ba, and where
a/(b+c+d): 0.80 to 1.30,
b/(b+c+d): 0.30 to 0.95,
c/(b+c+d): 0.05 to 0.60,
d/(b+c+d): 0.005 to 0.10,
e/(b+c+d): 0.0005 to 0.010,
b+c+d=1, and
x: 1.5 to 2.5, when the average particle diameter of primary particles of the positive electrode material is 0.1 μm or more, when the primary particles are aggregated to form secondary particles, and when the secondary particles have a comparatively wide particle size distribution, the filling rate of the particles is high. It is possible to determine the filling rate of the particles by pressing powder to produce a pellet, determining the density of the pellet, and defining the filling rate as the determined press density. Although there is no particular limitation on the upper limit of the average particle diameter of the primary particles, the upper limit is practically set to be 5 μm or less.

It is preferable that the positive electrode material have a density of 3.20 g/cc or more in the compacted state with a load of 95.5 MPa. Although it is preferable that the upper limit of the density be as high as possible, it is not practical that the density be more than 4.50 g/cc. When the press density is within this range, there is an increase in the capacity per unit volume of the electrode. It is more preferable that the press density be 3.40 g/cc or more.

The density of a compacted body, which is also called press density, pressure density, or pellet density (in a tablet form), indicates the properties of the product better than tapped density in a positive electrode material for a lithium secondary battery. When the press density is compared with the tap density, the two products can respectively have high and low tapped density conversely have low and high press density. This is thought to be because press density indicates comprehensive properties including a surface state and a particle size distribution. We believe that there is an increase in press density when Mg, Ba, Ca, K, and Na are added and that there is a supression in the rate of increase in mass when Ba, Ca, K, Na, S, C, Si, P, and B are added.

The particle size distribution of the secondary particles can be prepared so that press density is high. When a positive electrode material having high press density is used, since there is an increase in the electrode density of a positive electrode, there is an increase in discharge capacity per unit volume. When there is an increase in the ratio of secondary particles having a particle diameter less than 3 μm, there is a decrease in the coating performance of an electrode. Therefore, it is preferable that the average particle diameter of secondary particles be 3 μm or more, because excellent coating performance of an electrode is achieved.

A particle size distribution is determined by obtaining the distribution in the whole particle size range using a laser diffraction-scattering-type measuring method. “D₁₀, D₉₀^{”} respectively refer to particle diameters corresponding to the integrated values of 10% and 90% in a particle size distribution based on number of particles, and these are determined using a laser diffraction-scattering-type measuring method. It is more preferable that D₉₀−D₁₀ be 5.0 μm or more in the positive electrode material. When D₉₀−D₁₀ is within this range, since there is an increase in press density, there is an increase in battery capacity obtained due to an increase in the capacity per unit volume of the positive electrode material. It is further more preferable that D₉₀−D₁₀ be 7.0 μm or more and 20.0 μm or less.

Examples of a method of appropriately preparing the particle diameter distribution include one in which the particle diameter range is appropriately controlled before baking is performed and one in which the particle diameter distribution is controlled by crushing a sintered material as needed and by sorting the powder particles using, for example, a filter.

When the press density of a positive electrode material is high, there is an increase in the capacity per unit volume of a positive electrode, which contributes to an increase in battery capacity. However, it is possible that the density cannot be increased because the electrode brittleness or spalling of a positive electrode material or the like occurs in a rolling process depending on the particle diameter and kind of the positive electrode material used. If necessary, two or more of powders having different average particle diameters may be manufactured using different manufacturing conditions and these powders may be appropriately mixed together. A positive electrode material having high press density can be obtained by adjusting a baking temperature and crushing conditions among manufacturing conditions.

### Method of Manufacturing Positive Electrode Material for Lithium Secondary Battery

The method of manufacturing a positive electrode material will be described hereafter, but the method is not limited to the methods described below.

Examples of the raw materials to be used in manufacturing of a complex oxide, which is a positive electrode material, include oxides and materials which become oxides by a baking reaction when synthesis is performed in the manufacturing process.

Li, Ni, one or two chemical elements selected from Mn and Co, one, two, or more chemical elements selected from the group consisting of Mg, Al, Ti, Cr, and Fe, and one, two, or more chemical elements selected from the group consisting of B, C, Na, Si, P, S, K, Ca, and Ba are mixed into the raw material to be used in manufacturing of a complex oxide, which is a positive electrode material, and the mixture is baked. With this method, it is possible to manufacture a positive electrode material for a lithium secondary battery.

There is no particular limitation on what method is used for synthesizing the complex oxide and examples of the method include a solid-phase reaction method, one in which precipitates from a solution is baked, a spray combustion method, a molten salt method, and so forth.

As an example, a complex oxide can be synthesized by mixing a lithium source, a nickel source, and the like at respective rates in accordance with the chemical composition of the target lithium-nickel complex oxide, by appropriately selecting a temperature at which baking is performed in accordance with the kind of the complex oxide to be formed, and by baking the mixture in an atmosphere consisting of one, two, or more gasses selected from the group consisting of oxygen, nitrogen, argon, and helium at a temperature of about 700° C. to 950° C. It is also preferable that the baking described above be a baking process performed in a manner such that the mixture is sequentially subjected to a pre-baking stage in which the mixture is held at a temperature of 300 to 500° C. for 2 to 6 hours in an oxygen atmosphere, a heating stage in which the pre-baked mixture is heated at a heating rate of 5 to 30° C./min after the pre-baking has been performed and, subsequently, to the heating stage, a final baking stage in which the heated mixture is held at a temperature of 700 to 950° C. for 2 to 30 hours and that the baked complex oxide be subjected processing using a water-washing process in which the baked complex oxide is mixed with water and stirred, a dewatering process, and a drying process to manufacture a complex oxide.

Since Ni-containing positive electrode material is tends to absorb water, the material is not usually washed using water. However, when unreacted Li is removed in the water-washing process included in the process described above, it is possible to inhibit the occurrence of gelatification of a slurry for a positive electrode and inhibit the occurrence of the swelling of the battery.

As Ni source, a Co source and a Mn source, for example, oxides, hydroxides and nitrates of the respective chemical elements can be used. Since uniform mixing is important when Ni, Co, and Mn are added, it is particularly preferable that, for example, Ni—Co—(OH)₂, Ni—Mn—(OH)₂, and Ni—Co—Mn—(OH)₂ which are manufactured using a wet synthesis method be used as raw materials. The amounts of Ni—Co—(OH)₂, Ni—Mn—(OH)₂, and Ni—Co—Mn—(OH)₂ are adjusted so that the mole ratio of the amount of Co and Mn to the total amount of Ni, Co, and Mn is 0.05 to 0.60. In manufacturing these materials, it is desirable that dense powdery materials in the form of secondary particles of Ni—Co—(OH)₂, Ni—Mn—(OH)₂, and Ni—Co—Mn—(OH)₂ be manufactured using, for example, a wet synthesis method so that the average particle diameter is controlled to be 5 to 20 μm and the tapped density is controlled to be 1.8 g/cc or more.

As Li source, for example, hydroxides, nitrates, and carbonates are preferable. As compounds of one or more chemical elements selected from among Mg, Al, Ti, Cr, and Fe, which are N elements, and from among B, C, Na, Si, P, S, K, Ca, and Ba, which are L elements, for example, the oxides, hydroxides, carbonates, nitrates and organic acid salts of the respective chemical elements can be used.

It is preferable that a complex oxide be manufactured by baking after mixing Li compounds, a hydroxide which is formed by co-precipitating Ni, and M elements (one or two chemical elements selected from Mn and Co) and one, two, or more chemical compounds selected from among the oxides, nitrates, sulfates, carbonates, acetates, and phosphates as raw materials containing other constituent chemical elements.

Also, it is preferable that a complex oxide be manufactured by baking after mixing a hydroxide which is formed by co-precipitating N elements (one, two, or more chemical elements selected from the group consisting of Mg, Al, Ti, Cr, and Fe) or L elements (one, two, or more chemical elements selected from the group consisting of B, C, Na, Si, P, S, K, Ca, and Ba) and one, two, or more chemical compounds selected from among the oxides, nitrates, sulfates, carbonates, acetates, and phosphates as raw materials containing other constituent chemical elements.

### Lithium Secondary Battery

A positive electrode for a lithium secondary battery manufactured using the positive electrode material may be manufactured using an ordinary method. For example, a combined agent for a positive electrode is formed by mixing a carbon-based electrical conducting material such as acetylene black, graphite, and Ketjen black and binder into the powder of the positive electrode material. As the binder, for example, polyvinylidene fluoride, polytetrafluoroethylene, polyamide, carboxymethylcellulose, and acrylic resin can be used.

A positive electrode material layer is formed on a positive electrode current collector by coating slurry, which is formed by dispersing the combined agent for a positive electrode described above in a dispersion medium such as N-methylpyrrolidone, onto the positive electrode current collector composed of, for example, aluminum foil, by performing drying and press rolling.

For a lithium secondary battery in which the positive electrode material is used for the positive electrode, it is preferable that one or more of lithium salts having an anion such as ClO₄—, CF₃SO₃—, BF₄—, PF₆—, AsF₆—, SbF₆—, CF₃CO₂— and (CF₃SO₂)₂N— be used as solutes of an electrolyte solution. Both cyclic carbonate and chain carbonate may be used. Examples of a cyclic carbonate include propylene carbonate and ethylene carbonate (EC). Examples of a chain carbonate include, dimethyl carbonate, diethyl carbonate (DEC), ethyl methyl carbonate, methyl propyl carbonate, and methyl isopropyl carbonate.

For a separator, for example, a porous polyethylene and a porous polypropylene film may be used.

The negative electrode material of a lithium battery in which the positive electrode material is used for the positive electrode is a material capable of occluding and releasing lithium ions. Although there is no particular limitation on what kinds of materials are used to form a negative electrode material, examples of such materials include lithium metal, lithium alloys, carbon materials, carbon compounds, silicon carbide compound, silicon oxide compound, titanium sulfide, boron carbide compound, and oxides including mainly metals in 14 and 15 groups in the periodic table.

There is no particular limitation on the form of a lithium secondary battery in which the positive electrode material is used.

The battery is selected depending on its use from among batteries such as a cylinder type battery using an outer can having a cylinder form (circular cylinder form or square cylinder form), a flat type battery using an outer can having a flat form (flat form having a circular form or a square form in a plan view), and soft package type battery using a laminate film as an outer package.

### EXAMPLES

### Example 1

Ni—Co—(OH)₂ was prepared using a wet solution synthesis method by controlling the mole ratios of Ni and Co to obtain a raw material as a Ni and Co source. Commercially available reagents were used as other starting materials. Li hydrate was used as a Li source, Al₂O₃ was used as an Al source, and Ba(NO₃)₂ was used as a Ba source.

By weighing these starting raw materials to obtain the target compound composition and, by sufficiently mixing the weighed materials, a baking raw material was obtained. Baking was performed in an oxygen atmosphere, by first holding the material at a temperature of 400° C. for 4 hours mainly to remove water in the raw material, by thereafter heating the material at a heating rate of 5° C./min, holding the heated material at a baking temperature of 800° C. for a holding duration of 4 hours, and taking out the baked material from the furnace after cooling. The baked material taken out was crushed to obtain the powder of the positive electrode material. The obtained powder was mixed with water and stirred, dewatered and dried. Evaluation and determination such as particle size distribution determination, chemical composition analysis, and so forth were performed under the conditions described below. The evaluation results are given in Table 1. The symbol “-” in the table indicates a case where the corresponding item was not performed and not determined.

### Examples 2 to 22, and Comparative Examples 1 to 9

The same raw materials as used for Example 1 were used as a Ni source, a Co source, a Li source, an Al source, and a Ba source. Ni—Co—Mn—(OH)₂ was prepared using a wet solution synthesis method by controlling the mole ratios of Ni, Co, and Mn to obtain a raw material as a Mn source used for Examples 11, 12, 13, and 22 and Comparative Example 7. In addition, Ni—(OH)₂ was used as a Ni source for Comparative Example 5, and Ni—Mn—(OH)₂ was prepared using a wet solution synthesis method by controlling the mole ratios of Ni and Mn to obtain a raw material as a Ni and Mn source used for Comparative Example 6. Commercially available reagents were used as other starting materials. Sulfur powder was used as a S source, carbon black was used as a C source, SiO₂ was used as a Si source, KNO₃ was used as a K source, Mn₃O₄ was used as a Mn source, MgO was used as a Mg source, TiO₂ was used as a Ti source, Fe₂O₃ was used as an Fe source, P₂O₅ was used as a P source, Ca(NO₃)₂.4H₂O was used as a Ca source, Cr₂O₃ was used as a Cr source, NaNO₃ was used as a Na source, and H₃BO₃ was used as a B source. The powder of a positive electrode material was manufactured by performing processing using the baking process and the water-washing process under the same conditions as used for Example 1 while the compound composition was varied. In addition, evaluation was performed under the same conditions as used for Example 1, and the results are given in Table 1. A water-washing process was not used for Example 13, Example 22, and Comparative Example 9.

Subsequently, using these powders, the positive electrodes of lithium secondary batteries were manufactured, the battery performance of the batteries was evaluated as described below, and the results are given in Table 1.

By adding N-methyl-2-pyrrolidone to a mixture of 90 mass % of the powder of the positive electrode material for a lithium secondary battery of an example or a comparative example, 5 mass % of acetylene black, and 5 mass % of polyvinylidene fluoride, sufficiently kneading the mixture, applying the kneaded mixture to a current collector composed of aluminum to form a film having a thickness of about 150 μm, pressing the film with a pressure of about 200 kg/cm², punching the coated current collector into a disc having a diameter of 14 mm, and drying the disc at a temperature of 150° C. for 15 hours in vacuum, a positive electrode was obtained. A lithium metal sheet was used as a negative electrode, and a porous polypropylene film (marketed under the trade name of Celgard #2400) was used as a separator. In addition, 1 mole of LiClO₄ was dissolved in 1 L of a liquid mixture containing ethylene carbonate (EC) and dimethyl carbonate (DMC) at a volume ratio of 1:1 to obtain a non-aqueous electrolyte solution.

Using a testing cell which had been formed by assembling these members in a glove box filled with argon gas, the first discharge capacity was determined by performing charge and discharge within a voltage range of 2.75 to 4.25 V with a constant current density of 0.5 mA/cm². In addition, the first charge-discharge efficiency was calculated using the following equation:

first charge-discharge efficiency=[(first discharge capacity)/(first charge capacity)]×100.

By further performing charge-discharge measurement within a range of 2.75 to 4.25 V with a constant current density of 2.0 mA/cm², the rate performance was determined by calculation using the following equation:

rate performance (%)=[(discharge capacity for 2.0 mA/cm²)/(discharge capacity for 0.5 mA/cm²)]×100.

### Evaluation Method

### (1) Powder Properties

1) Average particle diameter of primary particles: The particle diameters are determined by observing the obtained positive electrode material using an electron microscope.

### 2) Particle Size Distribution of Secondary Particles

The particle size distribution in the whole particle size range is obtained using a laser diffraction-scattering-type measuring apparatus. “D₁₀, D₉₀^{”} respectively refer to particle diameters corresponding to the integrated values of 10% and 90% in a particle size distribution based on number of particles.

### 3) Press Density

A certain amount of the sample is charged into a mold having a diameter of 20 mm, and compressed with a pressure of 95.5 MPa, and then the press density is calculated from the measured height and mass of the sample.

A tapped density indicates how well powder is naturally compacted without pressure when the powder is composed of the mixture of particles respectively having large diameters and small diameters. A press density indicates how well powder is compacted under pressure when the powder is composed of the mixture of particles respectively having large diameters and small diameters.

### (2) Chemical Composition

By performing quantitative composition analysis for the obtained powder, the mole ratio of each constituent chemical element with respect to Ni content+M content+N content=1 mole was determined, and the overall composition of the sample is given in Table 1.

### (3) Increase in Mass

A certain amount of the obtained positive electrode material is charged into a sample bottle, then the sample bottle is kept in a constant temperature and humidity tank with atmospheric air having a temperature of 25±3° C. and a humidity of 60±5%, and 240 hours later, an increasing rate of mass is determined. The average value of the determined values of plural samples is defined as the rate of increase in mass.

### (4) Nail Penetration Test

A cell for a nail penetration test was prepared using the following method. By adding N-methyl-2-pyrrolidone to a mixture of 89 mass % of the powder of the synthesized positive electrode material for a lithium secondary battery, 6 mass % of acetylene black, and 5 mass % of polyvinylidene fluoride, sufficiently kneading the mixture, by applying the kneaded mixture to a current collector composed of aluminum having a thickness of 20 μm, and performing drying and pressing, the positive electrode was manufactured. The negative electrode was manufactured by adding N-methyl-2-pyrrolidone to a mixture of 92 mass % of carbon black, 3 mass % of acetylene black, and 5 mass % of polyvinylidene fluoride, sufficiently kneading the mixture, applying the kneaded mixture to a current collector composed of copper having a thickness of 14 μm, and performing drying and pressing. The thicknesses of the positive electrode and the negative electrode were respectively 75 μm and 100 μm. The electrolyte solution was prepared by dissolving 1 mole of LiPF₆ in 1 L of a liquid mixture containing ethylene carbonate (EC) and methyl ethyl carbonate (MEC) at a volume ratio of 1:1. The separator was composed of a porous polypropylene film. Using an aluminum laminate sheet, a square type battery having a length of 60 mm, a width of 35 mm, and a thickness of 4 mm was manufactured. By performing charge to 4.2 V with a current of 160 mA, and performing discharge to 3.0 V with the same current, the determined discharge capacity was 800 mA.

After having charged a battery with a constant voltage for 8 hours, a nail having a diameter of 2.5 mm was penetrated through the central part of the battery, and then the state of the battery was observed. When ignition was not recognized was judged as satisfactory, and when ignition was recognized was judged as unsatisfactory.

TABLE 1

| | | | Secondary | | | | First | | |
|---|---|---|---|---|---|---|---|---|---|
| | | | Particle size | | Rate of | First | Charge- | | |
| | | | distribution | Press | Increase | Discharge | Discharge | Rate | Nail |
| | | | (D₉₀-D₁₀) | Density | in Mass | Capacity | Efficiency | Performance | Penetration |
| | No. | Overall Composition | μm | g/cc | % | mAh/g | % | % | Test |
| Example | 1 | Li1.03 Ni0.79 Co0.19 Al0.02 | 13.47 | 3.43 | 0.44 | 185 | 91.0 | 86.3 | Satisfactory |
| | | Ba0.003 O2 | | | | | | | |
| | 2 | Li0.88 Ni0.72 Co0.26 Al0.02 | — | 3.41 | 0.44 | 173 | 87.0 | 87.5 | — |
| | | Ba0.003 S0.005 C0.001 O2 | | | | | | | |
| | 3 | Li1.01 Ni0.79 Co0.18 Al0.03 | 18.26 | 3.53 | 0.49 | 180 | 89.0 | 86.2 | — |
| | | Ba0.007 Si0.003 O2 | | | | | | | |
| | 4 | Li1.12 Ni0.79 Co0.18 Al0.03 | 12.81 | 3.56 | 0.43 | 182 | 88.8 | 87.7 | — |
| | | Ba0.003 K0.005 O2 | | | | | | | |
| | 5 | Li1.03 Ni0.92 Co0.05 Mn0.01 | 11.34 | 3.46 | 0.40 | 193 | 91.1 | 85.0 | Satisfactory |
| | | Al0.01 Mg0.01 Ba0.003 O2 | | | | | | | |
| | 6 | Li1.07 Ni0.83 Co0.09 Mn0.04 Al0.01 | — | 3.45 | 0.39 | 183 | 90.0 | 85.1 | — |
| | | Mg0.03 Ba0.003 S0.003 O2 | | | | | | | |
| | 7 | Li1.02 Ni0.90 Co0.05 Mn0.02 Al0.02 | — | 3.46 | 0.39 | 191 | 90.3 | 85.4 | — |
| | | Mg0.01 Ba0.003 C0.003 O2 | | | | | | | |
| | 8 | Li1.05 Ni0.85 Co0.09 Mn0.01 Al0.01 | — | 3.47 | 0.52 | 190 | 91.2 | 90.5 | — |
| | | Mg0.01 Ti0.03 Ba0.003 O2 | | | | | | | |
| | 9 | Li1.03 Ni0.87 Co0.10 Mn0.01 Al0.01 | — | 3.47 | 0.40 | 192 | 90.8 | 86.3 | — |
| | | Mg0.01 Ba0.003 Si0.001 O2 | | | | | | | |
| | 10 | Li1.00 Ni0.86 Co0.10 Mn0.01 Al0.02 | — | 3.45 | 0.45 | 192 | 90.5 | 87.0 | — |
| | | Mg0.01 Ba0.003 P0.003 O2 | | | | | | | |
| | 11 | Li1.03 Ni0.69 Co0.15 Mn0.15 Al0.01 | 13.11 | 3.41 | 0.31 | 176 | 90.3 | 88.7 | Satisfactory |
| | | Ba0.0008 O2 | | | | | | | |
| | 12 | Li1.02 Ni0.67 Co0.14 Mn0.14 Al0.05 | 12.53 | 3.40 | 0.28 | 172 | 89.5 | 87.3 | — |
| | | Ba0.003 S0.003 O2 | | | | | | | |
| | 13 | Li1.03 Ni0.37 Co0.29 Mn0.30 Al0.04 | — | 3.36 | 0.43 | 148 | 86.7 | 88.5 | — |
| | | Ba0.003 Si0.007 O2 | | | | | | | |
| | 14 | Li1.00 Ni0.81 Co0.09 Mn0.08 Al0.02 | — | 3.46 | 0.50 | 183 | 88.7 | 87.6 | Satisfactory |
| | | Ba0.005 O2 | | | | | | | |
| | 15 | Li1.04 Ni0.81 Co0.09 Mn0.09 Al0.01 | 6.58 | 3.40 | 0.43 | 181 | 88.6 | 88.0 | — |
| | | Ba0.003 S0.003 C0.002 O2 | | | | | | | |
| | 16 | Li1.03 Ni0.82 Co0.09 Mn0.07 Al0.02 | — | 3.45 | 0.49 | 184 | 90.1 | 88.3 | — |
| | | Ba0.003 Ca0.003 O2 | | | | | | | |
| | 17 | Li1.00 Ni0.79 Co0.09 Mn0.09 Al0.03 | 11.59 | 3.46 | 0.45 | 180 | 87.4 | 88.1 | — |
| | | Ba0.003 K0.005 O2 | | | | | | | |
| | 18 | Li1.03 Ni0.90 Co0.05 Al0.03 Mg0.02 | — | 3.49 | 0.45 | 189 | 89.9 | 86.3 | — |
| | | Ba0.003 S0.003 O2 | | | | | | | |
| | 19 | Li0.98 Ni0.85 Co0.09 Mn0.03 Al0.03 | 8.88 | 3.41 | 0.44 | 182 | 87.5 | 87.8 | — |
| | | Ba0.003 S0.003 C0.002 O2 | | | | | | | |
| | 20 | Li1.00 Ni0.82 Co0.09 Mn0.01 Al0.08 | 15.62 | 3.35 | 0.57 | 172 | 86.8 | 89.4 | — |
| | | S0.001 C0.006 O2 | | | | | | | |
| | 21 | Li1.04 Ni0.82 Co0.09 Mn0.03 Mg0.05 | — | 3.42 | 0.58 | 176 | 88.2 | 84.0 | — |
| | | Cr0.01 Na0.003 C0.003 O2 | | | | | | | |
| | 22 | Li1.17 Ni0.41 Co0.25 Mn0.33 Fe0.01 | 13.25 | 3.45 | 0.42 | 151 | 91.2 | 82.5 | — |
| | | Ba0.004 B0.003 O2 | | | | | | | |
| Comparative | 1 | Li1.03 Ni0.79 Co0.19 Al0.02 O2 | — | 3.22 | 0.78 | 189 | 90.0 | 80.3 | Unsatisfactory |
| Example | 2 | Li1.03 Ni0.81 Co0.19 O2 | 14.22 | 3.31 | 0.71 | 195 | 95.0 | 76.2 | Unsatisfactory |
| | 3 | Li0.75 Ni0.85 Co0.10 Al0.05 | 4.55 | 3.19 | 1.11 | 139 | 72.2 | 63.8 | Unsatisfactory |
| | | K0.003 O2 | | | | | | | |
| | 4 | Li0.78 Ni0.79 Co0.19 Al0.02 | 4.29 | 3.30 | 1.08 | 145 | 76.0 | 57.8 | — |
| | | Ba0.003 O2 | | | | | | | |
| | 5 | Li1.10 Ni0.82 Mn0.02 Mg0.15 | 10.01 | 3.56 | 0.78 | 139 | 79.0 | 82.6 | Satisfactory |
| | | Ti0.01 S0.003 O2 | | | | | | | |
| | 6 | Li1.12 Ni0.30 Mn0.66 Al0.03 Ti0.01 | 12.57 | 3.16 | 0.18 | 128 | 82.5 | 92.2 | Satisfactory |
| | | Ba0.003 K0.003 O2 | | | | | | | |
| | 7 | Li1.02 Ni0.15 Co0.65 Mn0.17 Al0.01 | 9.45 | 3.45 | 0.22 | 129 | 88.0 | 91.6 | — |
| | | Ti0.01 Fe0.01 Na0.003 O2 | | | | | | | |
| | 8 | Li1.03 Ni0.89 Co0.05 Mn0.03 Al0.02 | 9.45 | 3.27 | 0.77 | 189 | 90.8 | 85.1 | Unsatisfactory |
| | | Mg0.01 O2 | | | | | | | |
| | 9 | Li1.03 Ni0.79 Co0.19 Al0.02 | 3.98 | 3.24 | 2.33 | 168 | 73.1 | 68.0 | Satisfactory |
| | | Ba0.003 O2 | | | | | | | |
| | 10 | Li1.02 Ni0.78 Co0.19 Al0.03 | 8.56 | 3.35 | 0.50 | 125 | 78.7 | 72.2 | — |
| | | Ba0.015 O2 | | | | | | | |

### Description of Examples and Comparative Examples

In Example 1, where Al, which is an N element, and Ba, which is an L element, were added to the Li—Ni—Co—O-based material for Comparative Example 2, although there was a little decrease in first discharge capacity and first charge-discharge efficiency, there was an increase in rate performance and press density, there was a decrease in the rate of increase in mass, and a satisfactory result was obtained in a nail penetrating test, which means that Example 1 was an excellent positive electrode material having well-balanced properties. Moreover, in Example 5 where Mn, which is an M element, and Mg, which is an N element, were added, there was further increase in each of the properties.

In Comparative Examples 1, 2, and 8 where an L element was not added, and in Comparative Example 9 where water-washing was omitted, since the rate of increase in mass was much larger than in examples where an L element, which is effective in decreasing the rate of increase in mass, was added, there is concern that the slurry may become gelled in the manufacturing process of a positive electrode and that batteries may become swollen when Comparative Examples 1, 2, 8, and 9 are used for positive electrodes.

When comparing the measurement results of the press density for Examples 1, 3, 4, 5, and 17 having a value for D₉₀-D₁₀, which is a particle size distribution based on number of particles, of 5.0 μm or more with the results for Comparative Examples 3, 4, and 9 having a value for D₉₀−D₁₀ less than 5.0 μm, the differences are significant, and it is difficult to increase capacity per unit volume even if discharge capacity per unit mass is high in the case of the comparative examples, while it can be said that Examples 1, 3, 4, 5, and 17 are excellent in terms of capacity.

Since the complex oxides of Comparative Examples 1, 2, and 8, which are positive electrode materials not containing an L element, had low thermal stability and were unsatisfactory in a nail penetrating test, there is a problem with the safety of a battery.

Examples 1, 3, 11, 20, and 22 had sufficiently wide secondary particle size distribution. Examples 3, 4, 8, 9, and 18 had high press density. Examples 6, 7, 11, 12, and 13 had a small rate of increase in mass. Examples 5 and 7 through 10 had high first discharge capacity. Examples 1, 5 through 11, 16, and 22 had high first charge-discharge efficiency. Examples 8, 11, 13, 15 through 17, and 20 had high rate performance.

### INDUSTRIAL APPLICABILITY

A positive electrode for which the positive electrode material for a lithium secondary battery is used has high safety, high capacity, excellent rate performance, and a low rate of increase in mass in a certain atmosphere. A lithium secondary battery for which such a positive electrode is used can widely be used as a power supply that is small and light and has a high energy density for information-related devices, communication devices, and vehicles. A secondary battery which is manufactured using a positive electrode material for a lithium secondary battery can be equally applied to a cylinder type battery using an outer can having a cylinder form (circular cylinder form or square cylinder form), a flat type battery using an outer can having a flat form (flat form having a circular form or a square form in a plan view), and soft package type battery using a laminate film as an outer package.

1-13. (canceled)

14. A positive electrode material for a lithium secondary battery, the material comprising a complex oxide whose overall composition is expressed by LiₐNi_{b}M_{c}N_{d}LₑOₓ, where
M: one or two chemical elements selected from the group consisting of Mn and Co,
N: one, two, or more chemical elements selected from the group consisting of Mg, Al, Ti, Cr, and Fe,
L: one, two, or more chemical elements selected from the group consisting of B, C, Na, Si, P, S, K, Ca, and Ba, and where
a/(b+c+d): 0.80 to 1.30,
b/(b+c+d): 0.30 to 0.95,
c/(b+c+d): 0.05 to 0.60,
d/(b+c+d): 0.005 to 0.10,
e/(b+c+d): 0.0005 to 0.010,
b+c+d=1, and
x: 1.5 to 2.5.

15. The positive electrode material according to claim 14, wherein the material undergoes a change in mass in an amount of 0.60 mass % or less after having been exposed to atmospheric air having a temperature of 25° C. and a humidity of 60% for 240 hours.

16. The positive electrode material according to claim 14, wherein the material has a density of 3.20 g/cc or more in a compacted state with a load of 95.5 MPa.

17. The positive electrode material according to claim 15, wherein the material has a density of 3.20 g/cc or more in a compacted state with a load of 95.5 MPa.

18. The positive electrode material according to claim 14, wherein primary particles of the complex oxides having an average particle diameter of 0.1 μm or more are aggregated to form secondary particles.

19. The positive electrode material according to claim 18, wherein a difference between D₉₀ and D₁₀ based on number of particles is 5.0 μm or more in the particle size distribution of the secondary particles of the complex oxides.

20. A method of manufacturing the positive electrode material for a lithium secondary battery according to claim 14 comprising:
mixing raw material chemical elements or compounds containing raw material chemical elements,
baking the resultant raw materials at a temperature of 700° C. or higher and 950° C. or lower in a baking process, and
thereafter performing a treatment using a water-washing process.

21. A lithium secondary battery comprising a positive electrode composed of a positive electrode material containing the positive electrode material according to claim 14, a negative electrode composed of a negative electrode material, and an ion-conducting medium interposed between the positive electrode and the negative electrode and which conducts lithium ions.

22. A lithium secondary battery comprising a positive electrode composed of a positive electrode material containing the positive electrode material according claim 18, a negative electrode composed of a negative electrode material, and an ion-conducting medium interposed between the positive electrode and the negative electrode and which conducts lithium ions.

23. A lithium secondary battery comprising a positive electrode composed of a positive electrode material containing the positive electrode material according to claim 19, a negative electrode composed of a negative electrode material, and an ion-conducting medium interposed between the positive electrode and the negative electrode and which conducts lithium ions.

24. The positive electrode material according to claim 14, wherein the complex oxides are manufactured by baking after mixing Li compounds, a hydroxide formed by co-precipitating Ni and one or more chemical elements selected from Mn and Co and one, two, or more chemical compounds selected from among the oxides, nitrates, sulfates, carbonates, acetates, and phosphates of chemical elements other than the chemical elements described above.

25. The positive electrode material according to claim 18, wherein the complex oxides are manufactured by baking after mixing Li compounds, a hydroxide formed by co-precipitating Ni, and one or more chemical elements selected from the group consisting of Mn and Co and one, two, or more chemical compounds selected from among oxides, nitrates, sulfates, carbonates, acetates, and phosphates of chemical elements other than the chemical elements described above.

26. The positive electrode material according to claim 19, wherein the complex oxides are manufactured by baking after mixing Li compounds, a hydroxide formed by co-precipitating Ni and one or more chemical elements selected from the group consisting of Mn and Co and one, two, or more chemical compounds selected from among oxides, nitrates, sulfates, carbonates, acetates, and phosphates of chemical elements other than the chemical elements described above.

27. The positive electrode material according to claim 15, wherein primary particles of the complex oxides having an average particle diameter of 0.1 μm or more are aggregated to form secondary particles.

28. The positive electrode material according to claim 16, wherein primary particles of the complex oxides having an average particle diameter of 0.1 μm or more are aggregated to form secondary particles.

29. The positive electrode material according to claim 17, wherein primary particles of the complex oxides having an average particle diameter of 0.1 μm or more are aggregated to form secondary particles.

30. A lithium secondary battery comprising a positive electrode composed of a positive electrode material containing the positive electrode material according to claim 15, a negative electrode composed of a negative electrode material, and an ion-conducting medium interposed between the positive electrode and the negative electrode and which conducts lithium ions.

31. A lithium secondary battery comprising a positive electrode composed of a positive electrode material containing the positive electrode material according to claim 16, a negative electrode composed of a negative electrode material, and an ion-conducting medium interposed between the positive electrode and the negative electrode and which conducts lithium ions.

32. A lithium secondary battery comprising a positive electrode composed of a positive electrode material containing the positive electrode material according to claim 17, a negative electrode composed of a negative electrode material, and an ion-conducting medium interposed between the positive electrode and the negative electrode and which conducts lithium ions.
